(19) United States
(12) Patent Application Publication
(10) Pub. No.: US 2006/0153171 A1
(43) Pub. Date: Jul. 13, 2006

(54) IP telephone system

(75) Inventor: Shizuma Sakai, Hino-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/313,647

(22) Filed: Dec. 22, 2005

(30) Foreign Application Priority Data
Dec. 24, 2004 (JP) 2004-372858

(51) Int. Cl. H04L 12/66

(52) U.S. Cl. 370/352

(57) ABSTRACT

An IP telephone system having a plurality of terminals, comprising storage means storing relationships between terminal ID and user ID for each of the plurality of terminals, server performing call processing control related to each terminal logged in and registered, storage means storing upper limit numbers of the respective terminals possible to log in for each user in accordance with the user ID, comparison means comparing and collating between the number of the logged in and registered terminals and the upper limit number corresponding to the user ID on the basis of the user ID, when the user ID is input in the terminal, and controller allowing terminal with the user ID input thereto to be logged in and registered, when the number of the logged in and registered terminal is not more than the upper limit number as the result of comparison and collation from the comparison means.

### CROSS-REFERENCE TO RELATED APPLICATIONS

This application is based upon and claims the benefit of priority from prior Japanese Patent Application No. 2004-372858, filed Dec. 24, 2004, the entire contents of which are incorporated herein by reference.

### BACKGROUND OF THE INVENTION

1. Field of the Invention

The present invention relates to an Internet protocol (IP) telephone system for make a communication via an IP network (for example, the Internet).

2. Description of the Related Art

An Internet telephone (hereinafter, referred to as IP telephone) to make a communication via the IP network has been known. The IP telephone system has an server to perform communication control among IP telephone terminals. Additional providing of a registrar server to manage user IDs and the IP telephone terminals causes a possibility of communications by using the same user ID from any where through the IP telephone terminals connected to the IP network.

In the system performing such communication control, the burden of a server to manage IP addresses and the user IDs of the IP telephone terminals becomes heavy with the increase of the number of the IP telephone terminals. Since an IP address resource is finite, a method for effectively utilizing an address resource by converting a global address into a local address has been introduced [for example, refer to Jpn. Pat. Appln. KOKAI publication No. 11-122285 (page fourteenth, FIG. 1)].

Although this method is effective to save the IP address resource, this method cannot realize an ID management function to manage a large number of IP telephone terminals by using the same user ID. Accordingly, in the case of a large number of IP telephone terminals, the processing load related to the server to manage the IP addresses and the user IDs of the IP telephone terminals are still large.

The IP telephone system makes it possible for IP telephone terminals to make telephone calls from any where through an IP network by using the same user ID. However, this system has the problem such that a load of the server becomes large with an increase of the number of IP telephone terminals.

### BRIEF SUMMARY OF THE INVENTION

According to an aspect of the present invention, there is provided an IP telephone system having a plurality of telephone terminals, comprising: identification number storage means for storing relationships between telephone terminal identification numbers and user identification numbers for each of the plurality of telephone terminals; server means for performing call processing control related to each telephone terminal which is logged in and registered; upper limit number storage means for storing upper limit numbers of the respective telephone terminals possible to log in for each user in accordance with the user identification numbers; comparison and collation means for comparing and collating between the number of the logged in and registered telephone terminals and the upper limit number corresponding to the user identification number on the basis of the user identification number, when the user identification number is input in the telephone terminal; and log-in control means for allowing the telephone terminal with the user identification number input thereto to be logged in and registered, when the number of the logged in and registered telephone terminal is not more than the upper limit number as the result of comparison and collation from the comparison and collation means.

Additional advantages of the invention will be set forth in the description on which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an exemplary block diagram showing an IP telephone system regarding an embodiment of the present invention;

FIG. 2 is an exemplary flowchart showing an operation procedure of an IP telephone terminal in the IP telephone system regarding the embodiment of the present invention;

FIG. 3 is an exemplary view showing a table with an upper limit number of IP telephone terminals capable of being simultaneously log in by each user registered therein;

FIGS. 4A to 4D are exemplary views showing a registration list indicating correspondence between each IP telephone terminal and user ID;

FIG. 5 is an exemplary block diagram of an IP telephone system regarding a second embodiment of the present invention;

FIG. 6 is an exemplary block diagram of an IP telephone system regarding a third embodiment of the present invention; and

FIG. 7 is an exemplary block diagram of an IP telephone system regarding a fourth embodiment of the present invention.

### DETAILED DESCRIPTION OF THE INVENTION

Hereinafter, embodiments of the present invention will be explained by referring to the drawings.

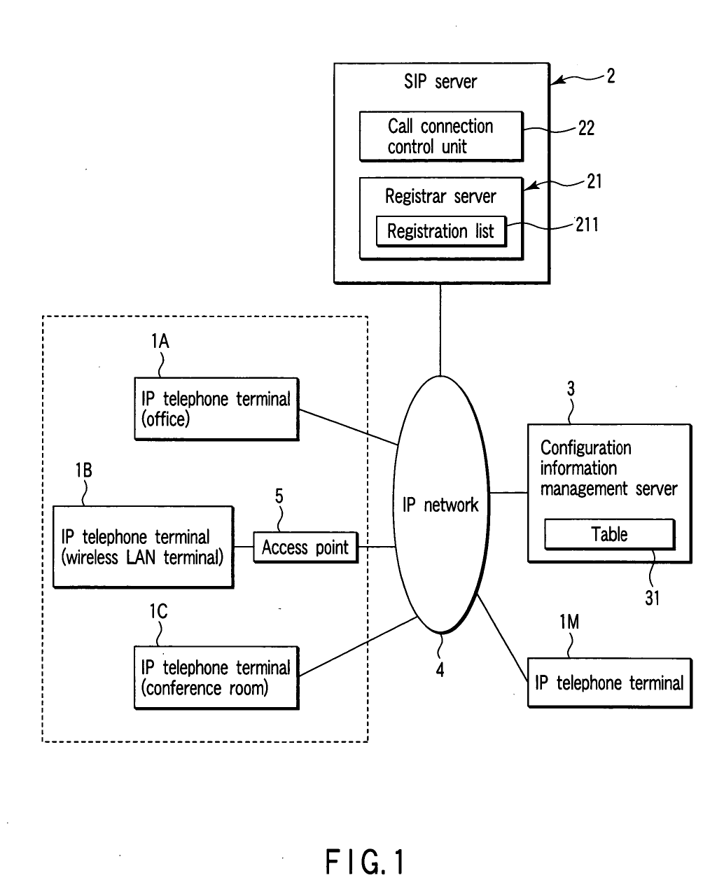

FIG. 1 is an entire view of an IP telephone system regarding an embodiment of the present invention.

In FIG. 1, the IP telephone system comprises a plurality of IP telephone terminals 1 (1A-1M), an SIP server 2, a configuration information management server 3 and an IP network 4 which connects each of the constituent elements given above.

The IP telephone system regarding the embodiment sets the upper limit number of the IP telephone terminals 1 allowed to simultaneously log in the IP telephone system for each user. This upper limit number is associated with each user to be stored in the configuration information management server 3. The IP telephone terminal 1 downloads the upper limit number for a user from the management server 3 and downloads the number of IP telephone terminals which have already logged in, from a registrar server 21 of the SIP server 2 to collate and compare between the two numbers in accordance with a log-in operation by the user. If the number of the IP telephone terminals which have already logged in reaches the upper limit number, the user who has performed the log-in operation is not allowed to log in the IP telephone system. Therefore, the IP telephone system can reduce IP address management, user ID management and call connection processing and prevent the load on the SIP server 2 from being increased.

Any user of the IP telephone system obtains each proper identification number (hereinafter, referred to as user ID) “U1”-“Un”. When a user make a telephone call by means of an IP telephone terminal 1 (for example, IP telephone terminal 1A), a user ID is input to an IP telephone terminal 1A.

It is assumed that three sets of IP telephone terminals 1A-1C are used by the users with user ID of “U1”. The IP telephone terminal 1A is installed in an office. An IP telephone terminal 1B is a wireless LAN terminal to be connected to the IP network 4 through an access point 5. An IP telephone terminal 1C is installed in a conference room. The user with a user ID of “Un” uses an IP telephone terminal 1M.

The SIP server 2 has a registrar server 21. The registrar server 21 has a registration list 211 therein. The registration list 211 registers information in which identification information of the IP telephone terminals 1A-1M and the user IDs “U1”-“Un” of the user who use the IP telephone terminals 1A-1M are made in pairs, respectively. The SIP server 2 also includes a call connection management unit 22 to control call connection of the IP telephone terminals which have logged in to the IP telephone system.

The configuration information management server 3 stores a table 31 to manage the upper limit number of the IP telephone terminals 1A-1M to which each user can simultaneously log in. The SIP procedure of the embodiment automatically performs log-in processing to the IP telephone system when the registrar server 21 receives registration information of terminal users from the IP telephone terminals 1 to store it in the registration list 211. The Sip server 2 does not perform log-in control to the IP telephone terminals 1.

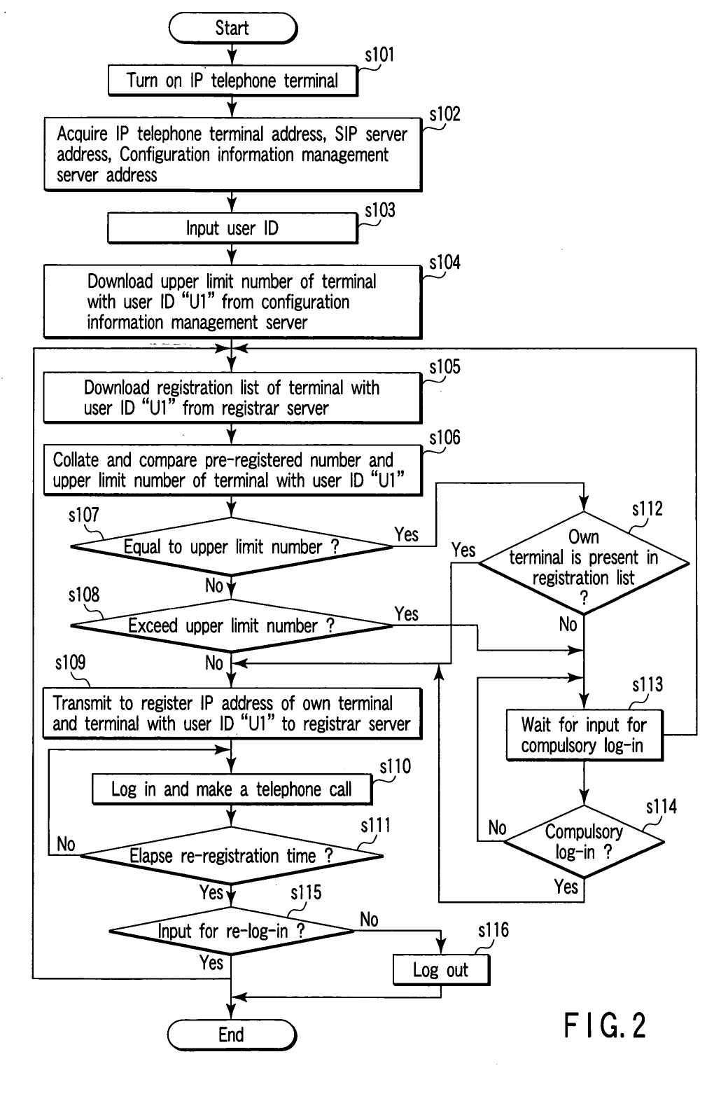

FIG. 2 is the exemplary flowchart showing the operation procedures in the IP telephone system in FIG. 1. Operations and processing procedures in the IP telephone system will be described in parts of (1) log-in processing up to the upper limit number, (2) compulsory log-in processing, and (3) re-log-in processing (continuation of log-in, and log-out).

(1) Log-In Processing Up to the Upper Limit Number

It is assumed that the IP telephone terminal 1A and the IP telephone terminal 1M are tuned on under a condition in which the user IDs and the IP addresses of the IP telephone terminals 1 are not registered in the registrar server 21 (step s101). Both IP telephone terminals 1A and 1M acquire own IP addresses, IP address of the SIP server 2 and IP address of the configuration management information server 3 in accordance with a dynamic host configuration protocol (DHCP) procedure (step s102).

Next, the user ID “U1” is input to the IP telephone terminal 1A (step s103). This user ID is input in accordance with a prescribed procedure through key buttons or the like of the IP telephone terminals 1. If the IP telephone terminals are ones to which personal computers or the like are used, the user IDs may be input through the keyboards of the computers or the like.

The IP telephone terminal 1A accesses to the IP network 4 and downloads configuration information, showing the upper limit number “2” of the IP telephone terminals 1 having the user IDs “U1” and possible to be simultaneously registered, from the configuration management information server 3 to read out it (step s104). The input of the user ID “Un” to the IP telephone terminal 1M results in downloading of “3” to the IP telephone terminal 1M in a procedure similar to one given above.

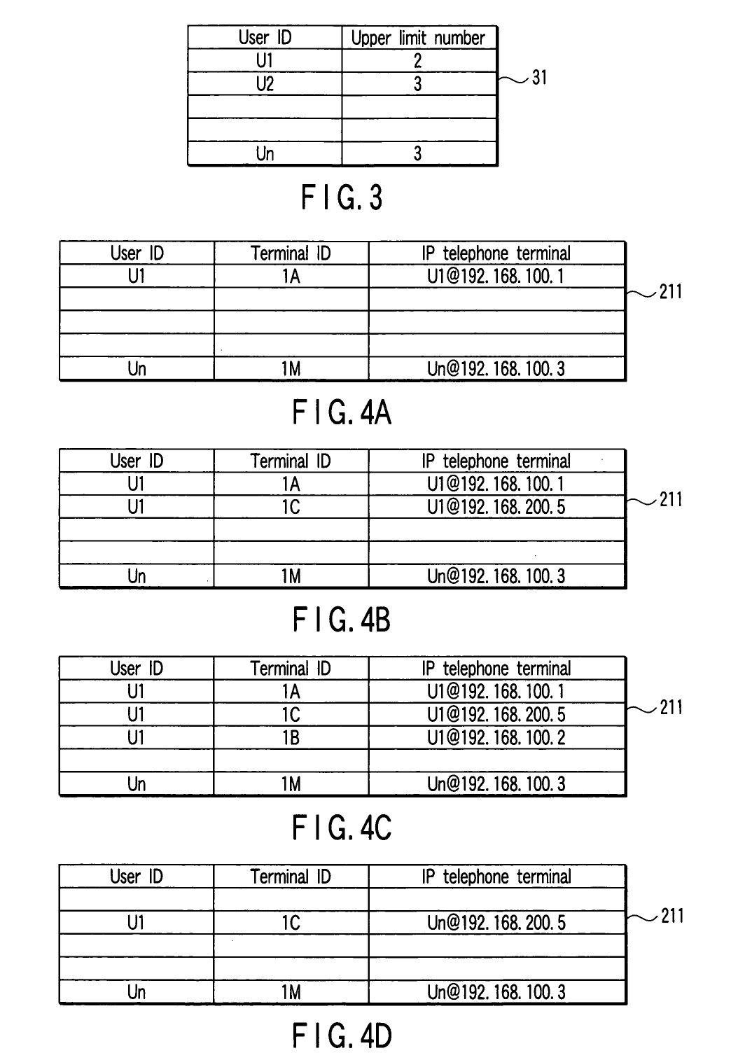

FIG. 3 is an exemplary view showing a table 31 stored in an internal memory of the configuration management information server 3. In FIG. 3, the upper limit numbers of the IP telephone terminals 1 possible to simultaneously log in are initially preset for each user “U1”-“Un” who have registered into the management server 3, as the users of the IP telephone system. Two sets for the User “U1” and three sets for the user “Un” are stored as the respective upper lime numbers in the table 31. This initial setting is executed by an administrator through, for example, a management terminal (not shown) connected to the management server 3 or the IP network 4. The initial setting gives the upper limit number of the IP telephone terminals, possible to log in for each user “U1”-“Un”, to the IP telephone system.

Next to this, each IP telephone terminal 1A and 1M downloads the registration list 211 with the input user ID (for example “U1” for telephone terminal 1A) and its user “U1” registered therein from the registrar server 21 to read out the already registered number “0” of the user “U1” (step s105). In this case, the number of the IP telephone terminals 1 is one by collating and comparing the number of the IP telephone terminals 1 to the upper limit number “2” of the user “U1”, which has been read out by downloading the table 31 from the management server 3, and the number “1” is not more than the upper limit number possible to log in, so that the IP telephone system determines that the telephone terminal may log in thereto (No, in steps s107 and s108). Then the IP telephone system transmits data of a suite of the IP address and the user ID of its own IP telephone terminal 1A to the registrar server 21 to register it (step s109).

Registrar server 21 receives this registration information to write, store and register it in the registration list 211 then the IP telephone terminal 1A is logged in the IP telephone system. The SIP server 2 then constantly monitors the registration list 211 of the registrar server 21 to perform call connection control between the registered IP telephone terminals 1.

That is to say, each IP telephone terminal 1A, if furthermore a telephone number of a call arrival destination is input by the user “U1” after logging in the IP telephone system, transmits the telephone number to the SIP server 2 to request call connection (step s110). The call connection control unit 22 of the SIP server 2 receives the call request then performs the call connection control between the IP telephone terminal 1 having the telephone number of the call arrival destination. These procedures up to the call connection processing go the same for the IP telephone terminal 1M.

FIG. 4 shows the registration list 211 showing combinations of each IP telephone terminal 1 and user IDs stored in the internal memory of the registrar server 21. The (a) of FIG. A shows a state immediately after the IP telephone terminals 1A and 1M are registered for the first time. The IP telephone terminal 1A is registered for a user who has a terminal ID “1A”, a terminal IP address “192.168.100.1” and a user ID “U1” and described as an address U1@192.168.100.1 that makes a pair with the user ID “U1”. And an IP telephone terminal 1M is registered for a user who has a terminal ID “1M”, an IP address “192.168.100.3” and a user ID ‘Un’ and described as “Un@192.168.100.3”. The IP address indicating the association to bring the user and the IP telephone terminal into a pair may be either a global address or a local address.

Next to this, it is assumed that the user turns on an IP telephone terminal 1B that is the wireless LAN terminal. The IP telephone terminal 1B operates the same operations as those of the aforementioned IP telephone terminal 1A, then downloads the registration list 211 from the registrar server 21 and conducts the operations up to step s106 in FIG. 2 in which the number of the already registered sets of the IP telephone terminals having the User ID “U1” is collated and compared to the upper limit number of sets possible to be registered. When reading out the registration list 211, it is determined that one set has already been registered for the user “U1” and log-in should be allowed because the total number of sets becomes two and settles not more than the upper limit number “2” even after registration of its own terminal and conducts processing after step s109 as similar to the processing of previous time. The (b) of FIG. 4 is the registration list 211 when the user “U1” is registered in the IP telephone terminal 1B. The IP telephone terminal 1B is registered in the user with a terminal ID “1B”, an IP address “192.168.200.5” and a user ID “U1” and described as “U1@192.168.200.5”.

(2) Compulsory Log-In Processing

Compulsory log-in is performed at the time when a user wants to further log in the IP telephone system in which other users have already logged in through the IP telephone terminals as many as the upper limit number. The IP telephone terminal 1 of the user who has forcibly logged in is treated to be logged out by timer processing so as to be settled within the upper limit number, as below-mentioned description (3) about re-log-in.

Furthermore, operations of an IP telephone terminal 1C in the case that the user “U1” further moves to a conference room from an office and tries to make a telephone call from the IP telephone terminal 1C placed in the conference room then enters a waiting state for the compulsory log-in will be described.

The user “U1” inputs the user ID “U1” to the IP telephone terminal 1C so as to make the IP telephone terminal 1C log in before making a telephone call (step s103). The IP telephone terminal 1C then downloads the maximum upper limit number “2” of the IP telephone terminals respectively having the user IDs “U1” from the management server 3 and a current registration list 211 shown in the (b) of FIG. 4 from the registrar server 21 (steps s104 and s105). And the IP telephone terminal 1C collates and compares between the pre-registered number of the IP telephone terminals 1 in relation to the user ID “U1” and the upper limit number (step s106). The IP telephone terminal 1C then reads the registration 211 to determine that more registration is not allowed and the user should wait for an input for the compulsory log-in, because the number of the IP telephone terminal 1C results in the third one and exceeds the upper limit number (Yes, in step s107) and the IP telephone terminal 1C (namely, own telephone terminal) has not registered in the registration list 211 (step s113).

After this, the IP telephone terminal 1C notifies an alarm of impossibility of log-in to the user “U1” by some means. Here, means for displaying a lamp (not shown) attached to the IP telephone terminal 1C (for example, lighting off a display for communicability, or lighting on alarm for incommunicability), for not outputting a tone signal from a telephone receiver, or for outputting an alarm for impossibility of log-in is used.

The user “U1” who has come to know the alarm determines that ordinal registration (log-in) is impossible. The user “U1” then tries to input a compulsory log-in command through a prescribed key button operation (Yes, in step s114). At this time, the IP telephone terminal 1C transmits registration information about a combination of the IP address “192.168.100.2” and the user ID “U1” to the registrar server 21 (step s109) to perform the compulsory log-in to the IP telephone system and further transmits a telephone number, which has been input by the user “U1”, to the SIP server 3 to make a telephone call (step s110).

The (c) of FIG. 4 is an exemplary view showing the registration list 211 of the registrar server 21 immediately after the implementation of the compulsory log-in. In the (c) of FIG. 4, the user “U1” should be registered two sets at a maximum fundamentally; however the compulsory log-in has been performed, so that total three sets of the IP telephone terminals 1 have been registered in the registration list 211 exceptionally.

On the contrary, it is assumed that the user suspends to make a telephone call from the IP telephone terminal 1C because of the impossibility of log-in of the user “U1” (No, in step s114). In this case, the IP telephone terminal 1C holds steady to wait for the input of the command of the compulsory log-in and does not conduct a log-in operation.

(3) Re-Log-In Processing (Continuation of Log-In, and Log-Out)

In SIP procedures, the registrar server 21 automatically deletes each IP telephone terminal 1 of which the time progress reaches a prescribed period, respectively (for example, thirty minutes) from the registration list 211. The IP telephone terminals 1 which have been logged in are logged out. Accordingly, each IP telephone terminal 1 therefore executes procedures to re-log in (re-register) to avoid log-out and allow them to be continuously used (step s111).

Two methods are provided for the re-log-in processing. A first method automatically conducts the re-log-in processing before a prescribed period (for example, thirty minutes) is elapsed (for example, fifteen minutes that is a half of the prescribed period) after the log-in. A second method respectively inputs the re-log-in commands to the IP telephone terminals 1.

(First Method)

In the first method, depending on the same manner in the conventional SIP procedures, each IP telephone terminal 1 automatically conducts the re-log-in processing at a time point when a half time of the prescribed period (for example, fifteen minutes) elapses by referring to a timer (not shown) after logging in. Now, it is assumed that a time period (for example, thirty minutes after the last log-in), in which the user “U1” requires to re-log-in (re-register) by means of the IP telephone terminal 1A in the office while the user “U1” is in meeting in the conference room, has elapsed.

Being in the conference room, the user “U1” cannot perform the re-log-in operation for the IP telephone terminal 1A; however the IP telephone terminal 1A automatically re-logs in before the fifteen minuets elapses (step s115).

That is, the IP telephone terminal 1A, of which the timing for the re-log-in has reached, inputs for the re-log-in (Yes, in step s115) to download the registration list 211 from the registrar server 21 (step s105) and compares to the upper limit number of the user “U1” (step s106).

If the number of the IP telephone terminals 1 by which the user “U1” are now logging in is less than the upper limit number allowed to be registered (No, in steps s107 and s108 in FIG. 2), the user “U1” transmits the IP address and the user ID of its own terminal to the registrar server 21 to overwrite-register them and logs in again.

It is assumed that the number of the IP telephone terminals by which the user “U1” are now logging in reaches the upper limit number allowed to be registered (Yes, in step s107 in FIG. 2). In this state, since the registered terminal number is equal to the upper limit number resulting from automatic re-log-in to check the already-registered terminal number and its own terminal has already registered in the registration list 211 (Yes, in step s112), the user “U1” transmits the IP address and the user ID “U1” of its own terminal to the registrar server 21 to register them for the re-log-in (step s109) and terminates the re-log-in processing. In the aforementioned two examples, the user “U1” can make a telephone call from the IP telephone terminal 1A without having to conduct the log-in processing when returning to the office.

In contrast, if the number of the IP telephone terminals 1 by which the user “U1” is now logging in exceeds the upper limit number allowed to be registered (Yes, in steps s107 and s108), the IP telephone terminal 1A is brought into a compulsory log-in waiting state. Since the user “U1” is in the conference room, an operation for the compulsory log-in is not conducted from the IP telephone terminal 1A in the office (No, in step s114). The IP telephone terminal 1A then expires and automatically logs out.

Similarly, the registrar server 21 watches the elapsed time period after receiving the registration information of the IP telephone terminal 1A by the internal timer. After the elapse of the prescribed period (thirty minutes) after the last log-in success of the IP telephone terminal 1A, the IP telephone terminal 1A is deleted from the registration list 211.

As mentioned above, if the number of the IP telephone terminals 1 registered in the registration list 211 is not more than the upper limit number of the user “U1”, the IP telephone terminals 1 which have logged in once are not deleted from the registration list 211 and retain the log-in states successively as long as commands for log-out are not input respectively by the user “U1”.

The first method is convenient because the IP telephone terminals 1 are not logged out and do not need procedures to perform re-log-in processing as long as the number of the IP telephone terminals 1 being in log-in is not more than the upper limit number.

(Second Method)

In the second method, the user inputs the re-log-in command to the IP telephone terminals 1 within the prescribed time period (wherein, thirty minutes) in which the registrar server 21 updates the registration list 211.

Now, it is assumed that the user “U1” makes a radio communication through an IP telephone terminal 1B that is a wireless LAN terminal and makes a telephone call at an appropriate time by using the IP telephone terminal 1A. However, when the time, immediately before (for example, one minute) the elapse of thirty minutes after the first log-in without making any telephone call by using the IP telephone terminal 1A, comes, the IP telephone terminal 1A displays an alarm to prompt the re-log-in (re-registration) by a lamp in accordance with the internal timer. The user “U1” recognizes the alarm by the lamp to perform the re-log-in and, for example, the user presses the key button in accordance with prescribed procedures so as to input the re-log-in command (Yes, in step s115). (As a matter of course, the IP telephone terminal 1 may automatically log out without output the alarm to prompt the re-registration as described above after the lapse of the re-registration time.)

The IP telephone terminal 1A with the re-log-in command input thereto downloads the registration 211 from the registrar server 21 in accordance with the procedures in step s105. When the IP telephone terminals 1A reads the registration list 211, the user “U1” determines that the IP telephone terminal 1B has also been registered and the IP telephone terminal 1A intends to be re-registered in a state of the upper limit number “2” of the user “U1” (Yes, in step s 107).

Then, the IP telephone terminal 1A further collates whether or not the IP address of its own terminal is present in the registration list 211 to read the description of U1@192.168.100.1 and determines that it is possible to register the IP telephone terminal 1A if its own IP address is present in the registration list 211 (Yes, in step s112). The IP telephone terminal 1A executes a procedure of the re-log-in processing to transmit the registration information of the ID of the user “U1” and the IP address of the IP telephone terminal 1A (step s109).

As another case, it is assumed that a time period (for example, thirty minutes), which is required for the IP telephone terminal 1A in the office to re-log in (re-register), elapses while the user “U1” is in a meeting in the conference room. Since the user “U1” is in the conference room, even when the registered number in relation to the compulsory log-in operations or the user “U1” does not reach the upper limit, the command operation for the re-log-in is not conducted (No, in step s115), so that the IP telephone terminal 1A expires and automatically logs out.

Likewise, the registrar server 21 watches the elapsed time period after receiving the registration information of the IP telephone terminals 1 by the internal timer. Then, after the elapse of the prescribed time period (thirty minutes) after the last log-in success of the IP telephone terminal 1A, the IP telephone terminal 1A is deleted from the registration list 211.

The second method is effective in the case that an allowable amount limit of terminals in the IP telephone system is strict, because the corresponding IP telephone terminal is automatically logged out and deleted from the registration list 211, even if the number of the IP telephone terminals during connection is not reaches the upper limit number as long as the re-log-in command is not input.

The (d) of FIG. 4 shows the registration list 211 of the registrar server 21 in a state that the IP telephone terminals 1A and 1B log out and only the IP telephone terminal 1C logs in after the compulsory log-in is performed.

The IP telephone terminal 1 which has become in a state waiting for the compulsory log-in may read out the registration list 211 of the registrar server 21 at a fixed time interval to detect the fact that the IP telephone terminals 1 become possible to log in.

For example, in the (c) of FIG. 4, while the IP telephone terminal 1M by which the user “U1” intends to make a telephone call at a moving destination executing the procedure of waiting for an input of the compulsory log-in (step s113), the IP telephone terminal 1M automatically downloads the registration list 211 from the registrar server 21 periodically, for example, with every several minute interval (step s105). The IP telephone terminal 1M then determines that the number of the IP telephone terminals to log in becomes not more than the upper limit number (here, assumed as two) even if the IP telephone terminal 1M itself is logged in by detecting the log-out of the IP telephone terminals 1A and 1B when the IP telephone terminal 1M is brought into a state of the (d) of FIG. 4. The IP telephone system can prompt the user “U1” to input the user ID and the telephone number to make a telephone call by indicating the fact that the IP telephone terminal 1M is in the state of possibility of log-in thereto by means of a lamp or the like. The IP telephone terminal 1C may automatically transmit the registration information and log in in stead of the log-in operation by the user “U1” when the IP telephone terminal 1C determines to be able to log in during waiting for the compulsory log-in.

Although the IP telephone system of the embodiment in the present invention is configured to comprise a configuration information management server 3 independently in FIG. 1, each of the servers may be configured to be independent with one another, or configured to be in a combination thereof or to be built in other server, other than the configuration shown in FIG. 1.

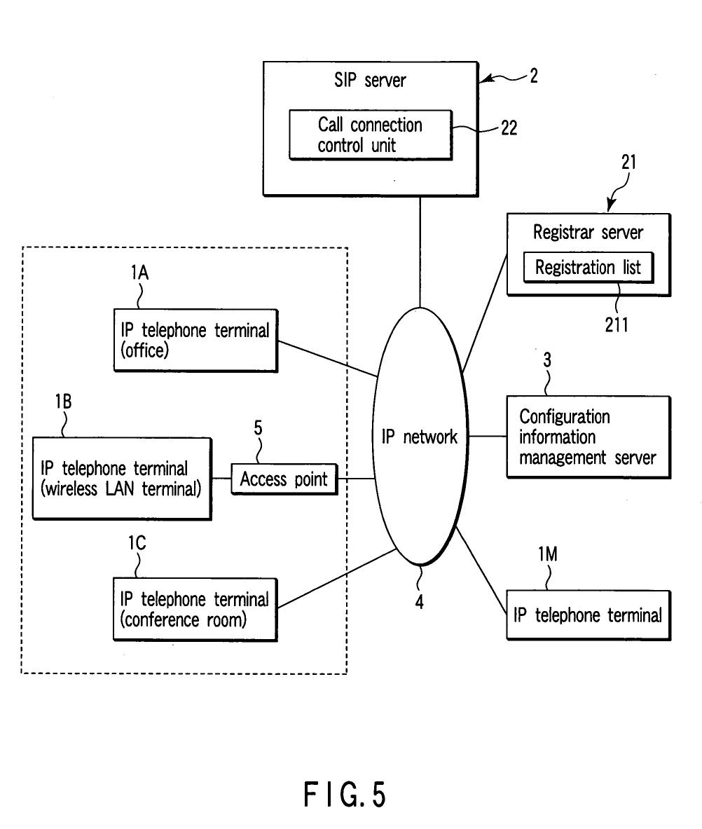

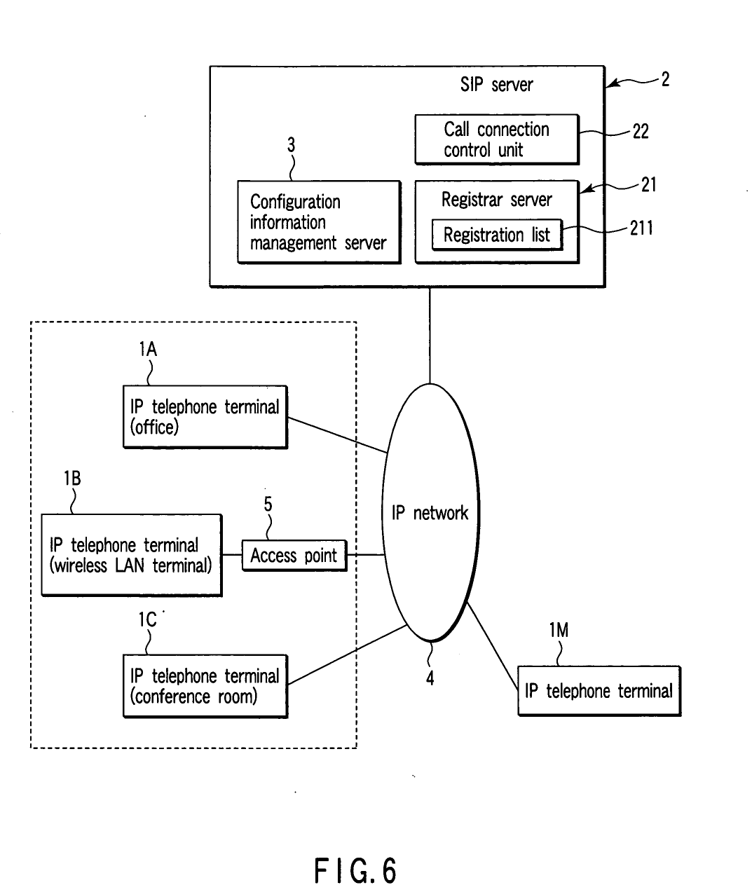

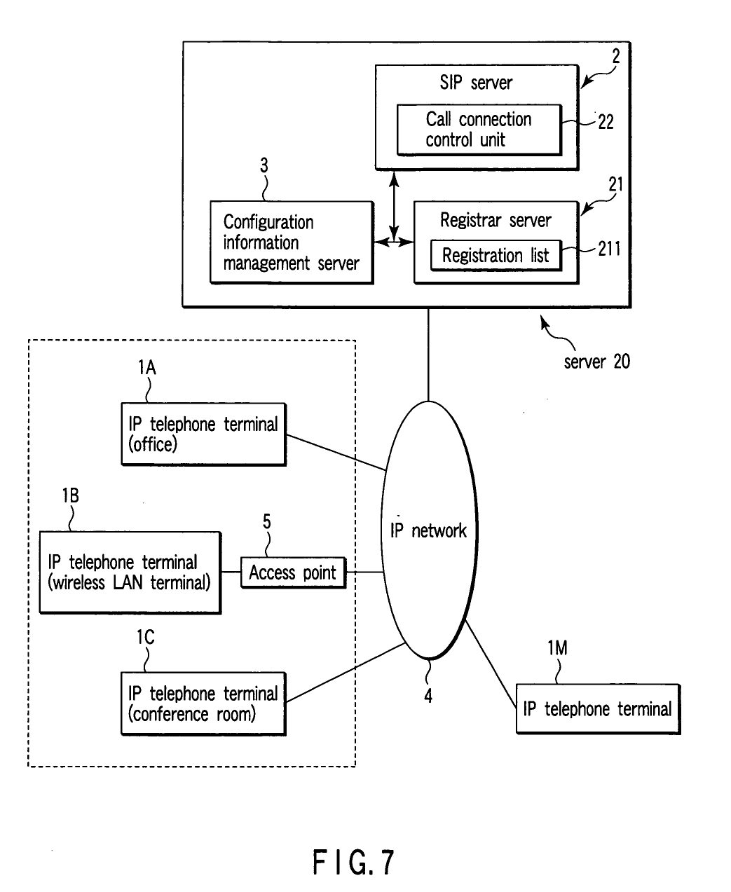

FIG. 5 is, for example, an exemplary block diagram showing a second embodiment of the invention in which the SIP server 3, registrar server 21 and configuration information management server 3 are independently configured to be connected to the IP network 4. FIG. 6 is an exemplary block diagram showing a third embodiment of the invention in which the registrar server 21 and configuration information management server 3 are built in the SIP server 2 and inner buses connect each server. Furthermore, FIG. 7 is an exemplary block diagram showing a fourth embodiment of the invention that is an apparatus in which a server 20 incorporates the IP server 2, registrar server 21 and configuration information management server 3 are incorporated, or that is a system configuration. In this case, each server is connected through either the IP network 4 or the inner buses. Even in the second to fourth embodiments of the invention, the operation procedures or the like in the IP telephone system, namely, among the IP telephone terminals and each server are similar to those of the first embodiment.

As given description, the IP telephone system of the present invention sets the upper limit number of the IP telephone terminals and makes the SIP telephone terminal itself control whether its log-in is allowed or not. Thereby, the situation, in which the user can make a telephone call from any IP telephone terminal without any limitation, is prevented. Consequently, the IP telephone system can suppress a load increase in IP address management, user ID management and call connection processing.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An IP telephone system having a plurality of telephone terminals, comprising:
identification number storage means for storing relationships between telephone terminal identification numbers and user identification numbers for each of the plurality of telephone terminals;
server means for performing call processing control related to each telephone terminal which is logged in and registered;
upper limit number storage means for storing upper limit numbers of the respective telephone terminals possible to log in for each user in accordance with the user identification numbers;
comparison and collation means for comparing and collating between the number of the logged in and registered telephone terminals and the upper limit number corresponding to the user identification number on the basis of the user identification number, when the user identification number is input in the telephone terminal; and
log-in control means for allowing the telephone terminal with the user identification number input thereto to be logged in and registered, when the number of the logged in and registered telephone terminal is not more than the upper limit number as the result of comparison and collation from the comparison and collation means.

2. An IP telephone system having a plurality of telephone terminals and a server to perform call processing control related to logged in and registered telephone terminals, wherein the server comprises:
an identification number storage means for storing relationships between telephone terminal identification, numbers and user identification numbers for each of the plurality of telephone terminals;
logged in telephone terminal number storage means for storing the number of the logged in and registered telephone terminals in association with the user identification numbers; and
upper limit number storage means for storing the upper limit numbers of the respective telephone terminals possible to log in for each user in accordance with the user identification numbers, and
each of the telephone terminal comprises:
reading means for reading out the number of the logged in and registered telephone terminals from the logged in telephone terminal number storage means on the basis of the user identification number and reading out the upper limit number corresponding to the user identification number from the upper limit number storage means, when the user identification number is input;
comparison and collation means for comparing and collating between the number of the logged in and registered telephone terminals and the upper limit number; and
log-in control means for logging-in and registering its own terminal to the server, when the number of the logged-in and registered telephone terminals is not more than the upper limit number as the result of the comparison and collation from the comparison and collation means.

3. The IP telephone system according to claim 1, wherein the log-in control means waits for log-in processing as long as a compulsory log-in command is input, when the number of the logged in and registered telephone terminals exceeds the upper limit number.

4. The IP telephone system according to claim 3, wherein
the comparison and collation means performs the comparison and collation at a defined timing with the start of waiting for the log-in processing; and
the log-in control means performs the log-in processing when the number of the logged in and registered telephone terminals after the start of the waiting becomes not more than the upper limit number.

5. The IP telephone system according to claim 3, wherein each of the telephone terminals starts waiting for the log-in processing and also displays by a lamp or outputs an alarm sound to notify the fact of impossibility of the log-in processing to a user.

6. The IP telephone system according to claim 2, wherein the log-in control means waits for log-in processing as long as a compulsory log-in command is input, when the number of the logged in and registered telephone terminals exceeds the upper limit number.

7. The IP telephone system according to claim 6, wherein
the comparison and collation means performs the comparison and collation at a defined timing with the start of waiting for the log-in processing; and
the log-in control means performs the log-in processing when the number of the logged in and registered telephone terminals after the start of the waiting becomes not more than the upper limit number.

8. The IP telephone system according to claim 6, wherein each of the telephone terminals starts waiting for the log-in processing and also displays by a lamp or outputs an alarm sound to notify the fact of impossibility of the log-in processing to a user.
